(19) United States
(12) Patent Application Publication
(10) Pub. No.: US 2008/0229608 A1
(43) Pub. Date: Sep. 25, 2008

(54) Method and Device for Drying Painted Vehicle Bodies

(76) Inventors: Josef Krizek, Holzgerlingen (DE); Werner Swoboda, Boeblingen (DE); Juergen Hanf, Tuebingen (DE)

Correspondence Address: FACTOR & LAKE, LTD, 1327 W. WASHINGTON BLVD., SUITE 5G/H, CHICAGO, IL, 60607, US

(21) Appl. No.: 11/597,397

(22) PCT Filed: May 12, 2005
(86) PCT No.: PCT/EP2005/005134

§ 371 Date: Dec. 20, 2007

(30) Foreign Application Priority Data
May 25, 2004 (DE) 102004025525.3

(51) Int. Cl. F26B 5/00; F26B 25/00

(52) U.S. Cl. 34/236; 34/282

(57) ABSTRACT

The invention relates to a method and a device for drying objects (2) in particular painted vehicle bodies. In said method, the objects (2) are displaced through a drying zone (6), in which they are cured in an inert atmosphere. The aim of the invention is to introduce the objects (2) into the drying zone (8), whilst at the same time preventing the entry of as much of the normal atmosphere of possible from the exterior. To achieve this, the objects (2) are conducted through a lock zone (7), which is located upstream of the drying zone (8) and in which the normal atmosphere lying outside the drying zone (8) and an inert gas atmosphere are present in strata as a result of a difference in densities. The objects (2) are displaced during their passage through the lock zone (7) from the normal atmosphere into the inert gas atmosphere by a motion comprising a vertical component.

The invention relates to a method for drying objects, in particular painted vehicle bodies, in which the objects are moved through a drying zone in which they are cured in an inert gas atmosphere,

and to
an apparatus for drying objects, in particular painted vehicle bodies, comprising:
a) a drying tunnel, the interior of which is filled with an inert gas atmosphere;
b) a conveying system with which the objects can be moved through the drying tunnel.

Very recently, paints which must be cured in an inert gas atmosphere, for example, in UV light, in order to prevent undesired reactions with components of the normal atmosphere, in particular oxygen, have gained increasing importance. These novel paints are distinguished by very high surface hardness and short polymerisation times. In painting installations operated with continuous through-put, the last-mentioned advantage is directly reflected reflected in shorter installation lengths, which, of course, leads to considerably lower investment costs.

Whereas, in conventional driers and drying methods operating with normal air as the atmosphere, the quantity of air which is introduced into the drier and removed therefrom is of lesser importance for cost reasons, in the case of inert gas atmospheres care must be taken to achieve the lowest possible consumption.

In known methods and apparatuses of the type mentioned in the introduction the objects to be dried are introduced in a substantially horizontal direction into the drying zone via door-like locks, or in some cases double locks. However, when the doors open a considerable exchange between the atmospheres inside and outside the drier can occur: the external normal atmosphere enters the drier the internal gas atmosphere escapes.

It is the object of the present invention to provide a method and an apparatus of the type mentioned in the introduction with which it is possible to operate using the smallest possible quantities of inert gas.

This object is achieved, with regard to the method, in that, before entering the drying zone, the objects are conducted through a lock zone in which the normal atmosphere present outside the drying zone and an inert gas atmosphere are present as strata one above the other as a result of a difference of densities, the objects being transferred as they pass through the lock zone from the normal atmosphere to the inert gas atmosphere by a movement which includes a vertical component.

According to the invention, therefore, the normal atmosphere present outside the drier and the inert gas atmosphere prevailing inside the drier are no longer separated (only) by doors. Rather, the normal atmosphere and the natural gas atmosphere are stratified one above the other in a special lock zone, being able to communicate with one another via large-area openings without a significant gas exchange taking place between the atmospheres. The objects to be dried can be transferred from the normal atmosphere to the inert gas atmosphere through the above-mentioned large-area opening. If this is executed carefully, only comparatively small turbulence with correspondingly small gas exchange takes place. With an appropriately large density difference the stratification of the two atmospheres is also maintained over a long period.

The embodiment of the inventive method in which the inert gas atmosphere has a higher density than the normal atmosphere is especially advantageous. In this case, the inert gas atmosphere is located below the normal atmosphere; because of its relatively high density, the inert gas atmosphere is especially well-suited to flushing away residues of the normal atmosphere and other impurities which are entrained with the objects.

In this case the inert gas is advantageously CO₂, that is, a comparatively low-cost gas.

It is not essential that the inert gas has a different density to the normal atmosphere as a result of its chemical constitution. It is also possible for the inert gas to be cooled to so low a temperature that its density is higher than that of the normal atmosphere.

Alternatively, the inert gas atmosphere may have a lower density than the normal atmosphere and is therefore stratified above the normal atmosphere. As a gas which has low density because of its chemical constitution helium, for example, is possible.

However, in this case, too, is also possible to use gases which do not inherently have low density as a result of their chemical constitution, but which can be heated to so high a temperature that their density is lower than that of the normal atmosphere.

Especially low entrainment of normal atmosphere and other impurities into the actual drying zone are achieved with the method in which the objects, after passing through the first inert gas atmosphere, are conducted through a second inert gas atmosphere, the two inert gas atmospheres being stratified one above the other because of a difference of density. In this case normal atmosphere and other impurities entrained by the objects very largely remain behind in the first inert gas atmosphere which, despite large-area communication, to a large extent remains lastingly separated from the second inert gas atmosphere prevailing in the drying zone because of the stratification. In the first inert gas atmosphere a certain degree of contamination can be accepted; if it reaches a given level, the comparatively small volume of the first inert gas atmosphere can be either discharged or purified.

The second inert gas atmosphere may have a lower density than the first inert gas atmosphere because of its chemical constitution. In this case nitrogen or helium preferably come into consideration as the second inert gas, and CO₂ as the first inert gas. Alternatively, the second inert gas may be helium and the first inert gas nitrogen.

To repeat, it is not necessary for the density difference between the two inert gases to be based on chemical constitution. Rather, it is possible that different densities are imparted to the two inert gases by different temperatures. In this case it is advantageous for cost reasons if both inert gases are CO₂ or nitrogen.

The method according to the invention is advantageously carried out in such a way that, after passing through the drying zone, the objects are moved through a second lock zone from the inert gas atmosphere of the drying zone into the normal atmosphere present downstream of the drying zone, the second lock zone having a similar configuration to the first lock zone although their atmospheres are traversed in the reverse sequence. This second lock zone prevents gas exchange between the atmospheres inside and outside the drying zone at the outlet of the drying zone in a similar way as is done by the first lock zone at the inlet of the drying zone.

The above-mentioned object is achieved, with regard to the apparatus, in that the apparatus further comprises:
c) an inlet lock located before the drying tunnel and having:
   ca) an inlet chamber into which the objects can be introduced via an inlet opening and in which the normal atmosphere present outside the apparatus substantially prevails;
   cb) a second chamber which is located at a different vertical level than the inlet chamber, which communicates with the latter via a large-area opening and is filled with an inert gas atmosphere,
   cc) the normal atmosphere and the inert gas atmosphere being stratified one above the other as a result of different densities;
d) a transfer mechanism with which the objects can be transferred from the inlet chamber to the second chamber by a movement including a vertical component.

The advantages of this apparatus according to the invention are analogous to those mentioned above for the method according to the invention. When it is stated in connection with the inlet chamber that the normal atmosphere present outside the apparatus prevails “substantially” in said inlet chamber, the following is meant: because of the gas exchange taking place between the atmosphere in the inlet chamber and the atmosphere in the second chamber—which gas exchange, although small, nevertheless takes place to a certain extent—but also because of inert gas which is directed in the inlet chamber against the objects for flushing, the atmosphere in the inlet chamber may to a certain extent have a higher inert gas content than the “real” normal atmosphere present outside the apparatus.

Claims 15 to 26 specify embodiments of the inventive apparatus which are analogous, in terms of apparatus, to the above-mentioned variants of the method. The advantages associated with these embodiments of the apparatus correspond to those mentioned with regard to the method.

The transfer mechanism may advantageously include a swivelling arm one end of which is articulated to a fixed location and the other end of which includes a holding device for the object. With this type of transfer mechanism, therefore, the object is moved through the inlet lock on an arcuate path, that is, with a type of movement in which a translational motion in the horizontal direction is combined with the movement in a vertical direction which is required for the transition between the inlet chamber and the second chamber.

If, in addition, the holding device is connected to the swivelling arm by an articulated joint, motion kinematics can be achieved for the objects which permit, on the one hand, immersion in the inert gas atmosphere which is as “smooth” and turbulence-free as possible and, on the other, short dimensions of the inlet lock in the direction of movement.

Alternatively, the transfer mechanism may include at least one lifting table. In this case the vertical movement and the horizontal movement take place successively in the inlet lock.

For reasons already mentioned, it is advantageous if the apparatus includes at the end of the drying tunnel an outlet lock constructed similarly to the inlet lock but having atmospheres which are traversed in the inverse sequence.

Embodiments of the invention are described in more detail below with reference to the drawings, in which:

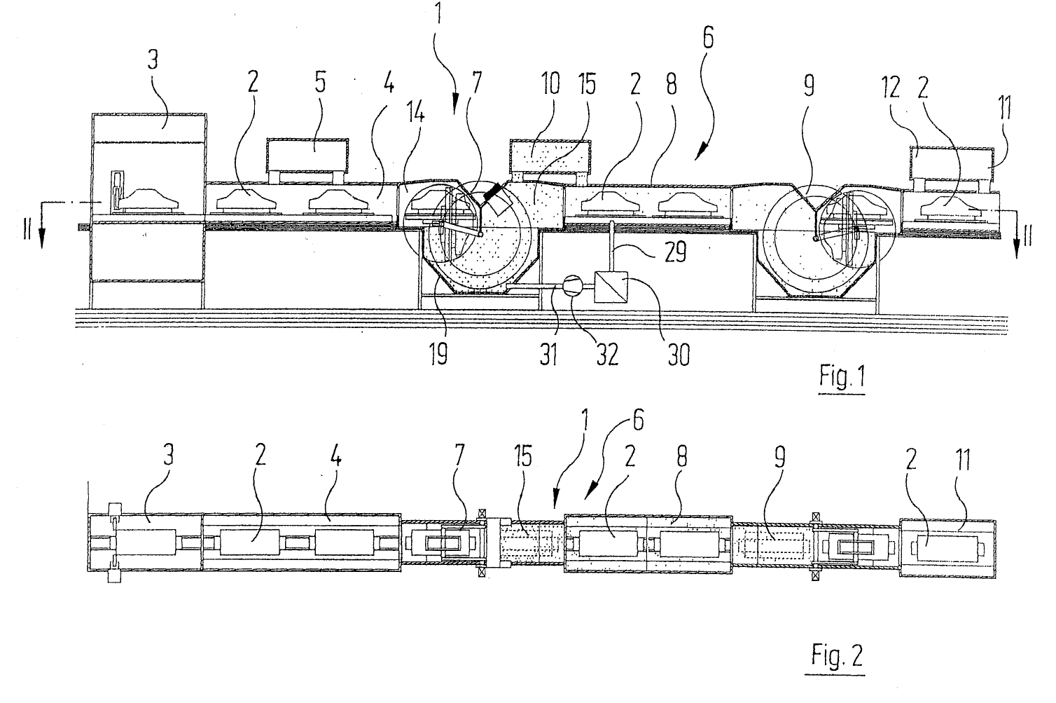

FIG. 1 shows a portion of a painting installation with a first embodiment of a drier according to the invention in vertical section;

FIG. 2 shows a section through the installation of FIG. 1 along the line II-II in FIG. 1;

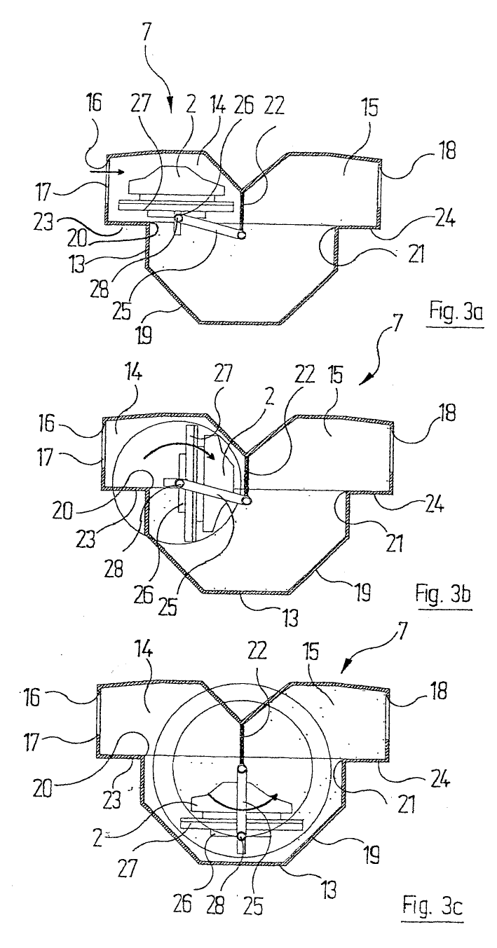

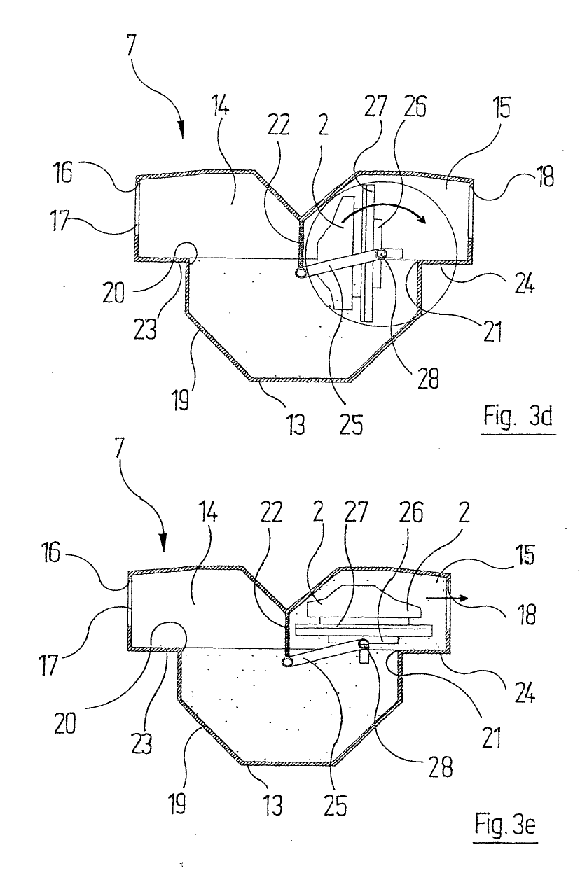

FIGS. 3a to 3e show different positions of a vehicle body in a lock of the installation of FIGS. 1 and 2;

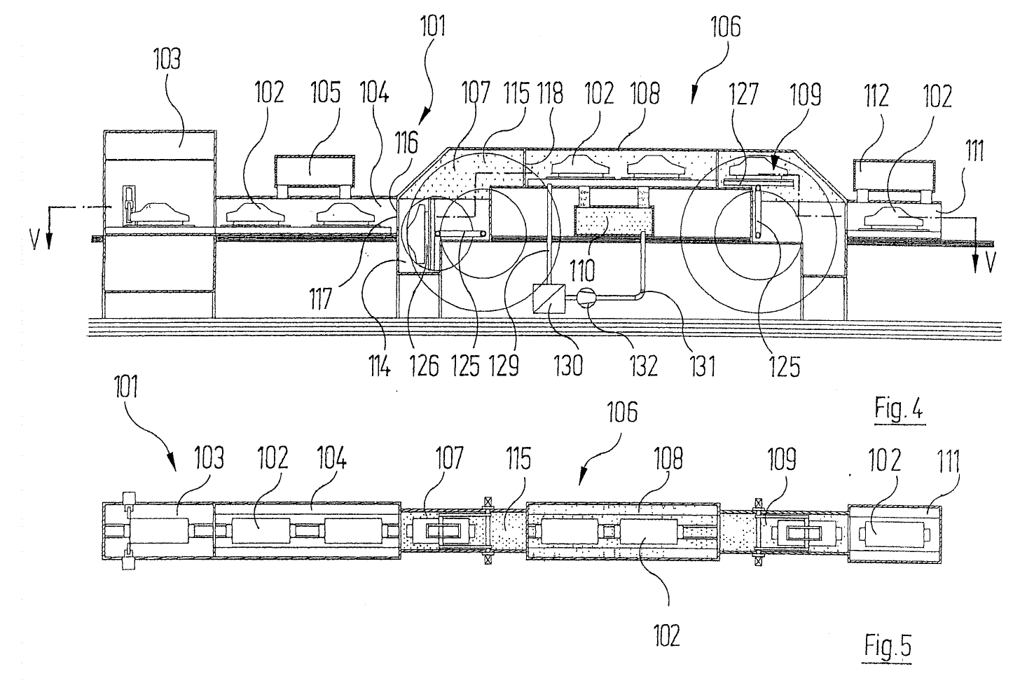

FIG. 4 shows a portion of a painting installation with a second embodiment of a drier according to the invention in vertical section;

FIG. 5 shows a section along the line V-V in FIG. 4, which line contains two steps and is partially offset vertically;

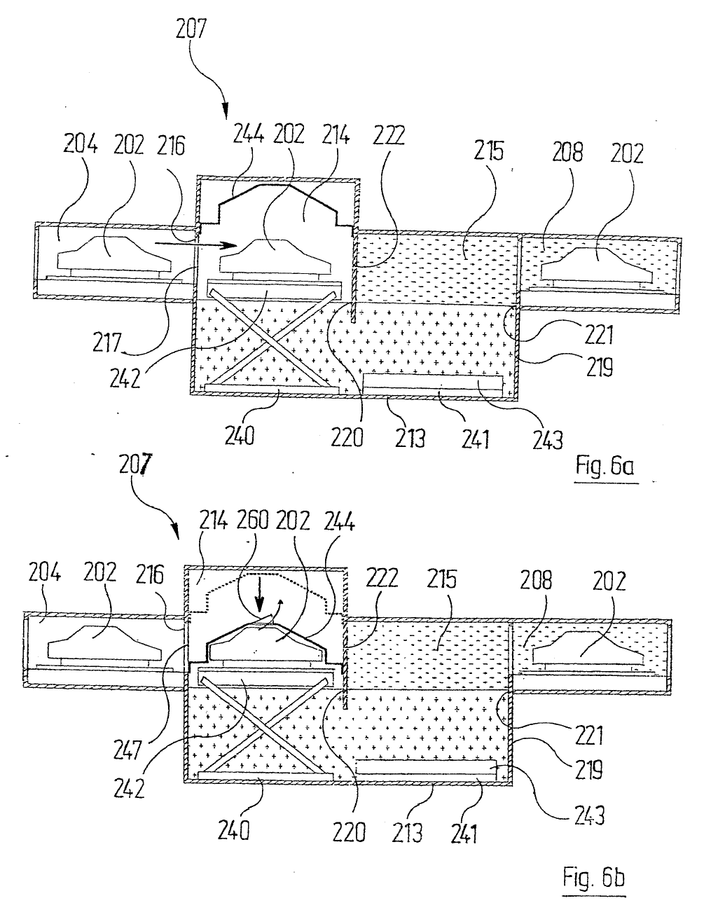

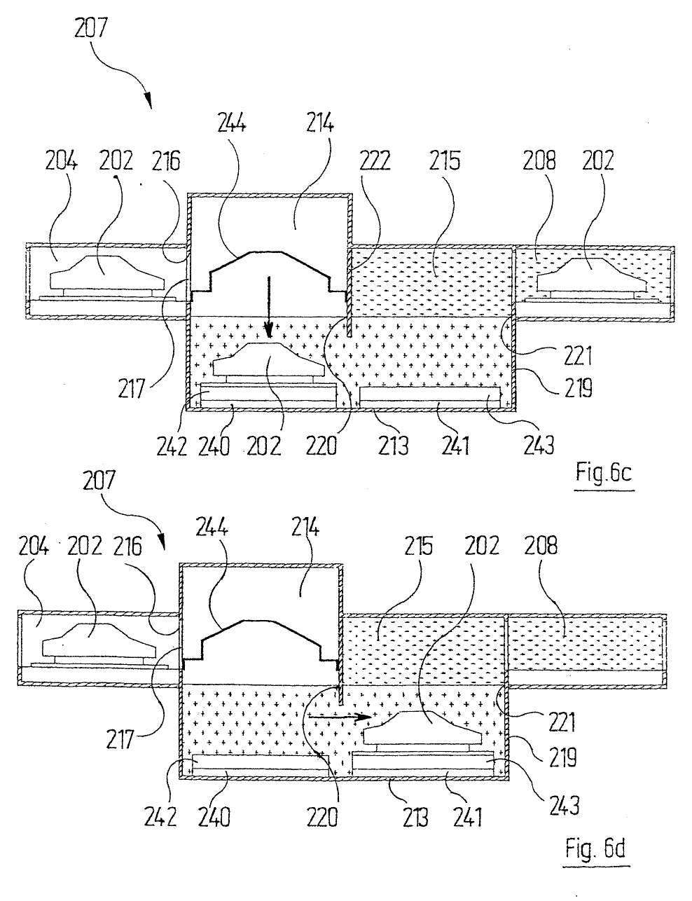

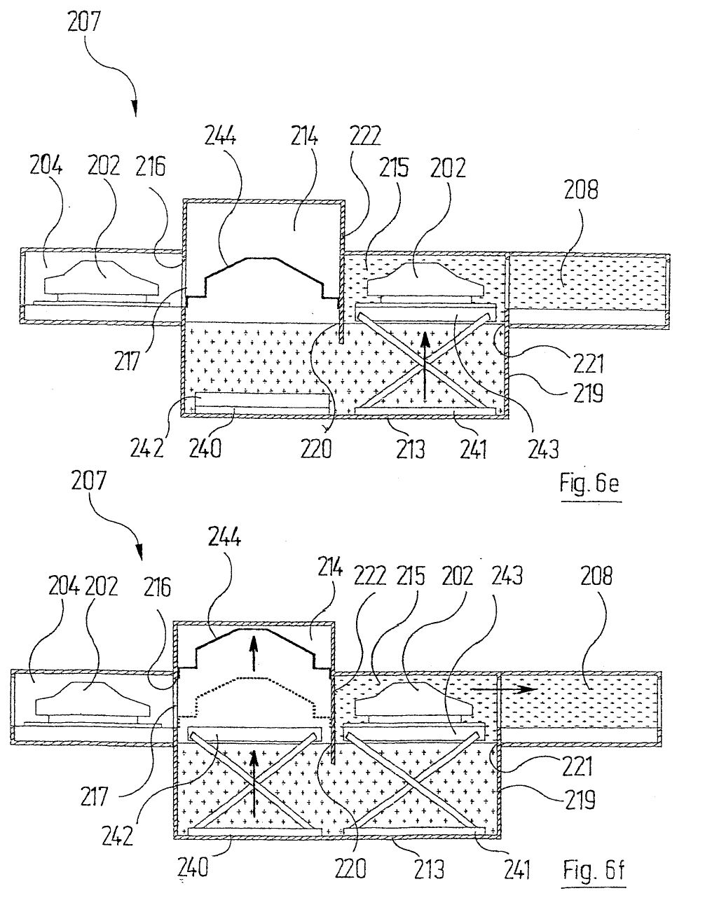

FIGS. 6a to 6f show a third embodiment of a lock according to the invention with different positions of the vehicle body;

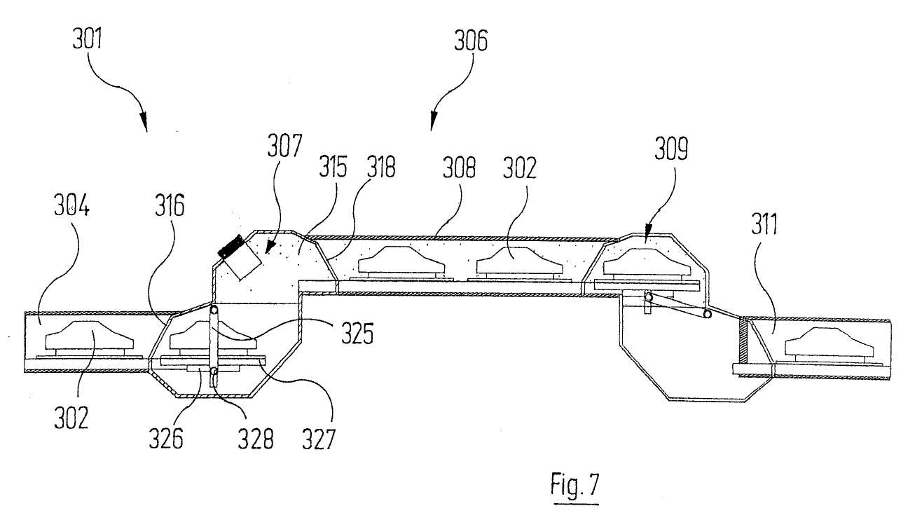

FIG. 7 shows a portion of a painting installation with a fourth embodiment of the drier according to the invention in vertical section.

Reference will first be made to FIGS. 1 and 2, in which a portion of a painting installation is denoted as a whole by reference 1. The painting installation 1 is used for painting vehicle bodies 2; various treatment stations (not shown) are arranged in known fashion before and after the portion illustrated. The vehicle bodies 2 pass through the painting installation 1 in FIGS. 1 and 2 from left to right. They first enter the spray cabin 3 in which they are coated with paint in known fashion. The precise construction of the spray captain 3 and the type of application of the paint is irrelevant in the present context.

From the spray cabin 3 the vehicle bodies 2 first reach a pre-drier 4, the detailed construction of which is likewise not of interest and is known to the person skilled in the art. In the pre-drier 4 a first expulsion of the solvents takes place at a temperature from 40° C. to 150° C. For this purpose the air contained in the pre-drier 4 is circulated, for example, via a heating unit 5.

The pre-drying may also be carried out by relatively long residence times in an unheated, ventilated zone instead of a pre-drier, solvents being evaporated and degassed, depending on the type of paint used.

From the pre-drier 4 the vehicle bodies 2 are moved into the main drier 6, which is made up of an inlet lock 7, a drying tunnel 8 and an outlet lock 9.

An inert gas atmosphere is present in the drying tunnel 8; it is therefore filled, for example, with CO₂, nitrogen or in some cases with helium. A temperature from 40° C. to 150° C. prevails in the drying tunnel 8, and is obtained in the embodiment illustrated by circulating the inert gas via a heating unit 10. In the locks 7 and 9 the vehicle bodies 2 are moved into and out of the inert gas atmosphere of the drying tunnel 8, as will be explained below with reference to FIGS. 3a to 3e.

From the outlet lock 9 of the drier 6 the vehicle bodies 2 are moved into a cooling zone 11 which again contains normal atmospheric air which is maintained at the desired temperature by means of a cooling unit 12.

As is shown in FIG. 2, in particular the width of the locks 7 and 9 and the internal width of the drying tunnel 8 exceed the width of the vehicle bodies 2 to be treated by the smallest possible amount. In this way the quantity of inert gas which is required and optionally circulated in the locks 7, 9 and in the drying tunnel 8 is kept as small as possible.

Reference will now be made to FIGS. 3a and 3b which show the construction of the lock 7, as an example for the locks 7, 9, and the manner in which the vehicle bodies 2 are transferred from the normal atmosphere prevailing in the pre-drier 4 to the inert atmosphere present in the drying tunnel 8. The construction of the outlet lock 9 is in principle the same, although the vehicle bodies 2 are transferred from the inert gas atmosphere of the drying tunnel 8 to the normal atmosphere of the cooling zone 11 in the inverse direction.

The lock 7 includes a housing 13 having an inlet chamber 14 and an outlet chamber 15. The inlet chamber 14 is located at the same height as the tunnel of the pre-drier 4; its inlet opening 16 can be closed with a roll-up door 17. The outlet chamber 15 is located at the same height, is aligned with the drying tunnel 8 and communicates with the interior thereof via an outlet opening 18. The outlet opening 18 may also be provided with a roll-up door.

Below the inlet chamber 14 and the outlet chamber 15 the housing 13 of the lock 7 forms a kind of “immersion bath” 19, this designation being explained below. The immersion bath 19 communicates via comparatively large-area openings 20, 21 with both the inlet chamber 14 and the outlet chamber 15.

Direct atmospheric communication between the inlet chamber 14 and the outlet chamber 15 is prevented by a vertically disposed partition 22, which extends downwardly to somewhat below the level of the floor 23 of the inlet chamber 14 and the floor 24 of the outlet chamber 15.

A swivelling arm 25 is pivoted to the lower edge of the partition 22, which swivelling arm 25 can be swivelled in a motor-driven manner from the position shown in FIG. 3a, in which its free end extends into the lower region of the inlet chamber 14, to the position shown in FIG. 3e, in which its free end extends into the lower region of the outlet chamber 15, and vice versa.

A mounting frame 26 which includes a platform 27 carrying the vehicle body 2 is pivoted to the free end of the swivelling arm 25. The platform 27 is provided with a conveying system which is compatible with the conveying system present in the remaining part of the installation. The mounting frame 26 can be rotated through at least 360° and back by means of a motor (not shown).

The outlet chamber 15 of the lock 7 contains the same inert gas atmosphere as the drying tunnel 8 at approximately the same temperature. The immersion bath 19 is also filled with inert gas; however, this gas has a higher density than the inert gas in the outlet chamber 15 and the normal atmosphere in the inlet chamber 14, so that it forms substantially a “substratum” to both the atmosphere in the inlet chamber 14 and the inert gas atmosphere in the outlet chamber 15. Mixing of the different atmospheres via the openings 20, 21 is kept as low as possible.

Different densities of the inert gas atmospheres in the outlet chamber 15 and the immersion bath 19 can be achieved in different ways: firstly, it is possible to use different gases as inert gases. For this purpose the immersion bath 19 may be filled, for example, with CO₂ and the outlet chamber 15 with nitrogen. Because CO₂ is heavier than nitrogen and is also heavier than the atmosphere contained in the inlet chamber 15, about which more will be said below, the separation of the atmospheres in the desired manner is maintained.

However, it is preferred if the same inert gas, for example, only nitrogen, is used in the outlet chamber 15 and in the immersion bath 19. In this case the higher density of the inert gas in the immersion bath 19 is brought about by a lower temperature. For example, the temperature of the inert gas atmosphere in the immersion bath 19 may be approximately 20° C., while the above-mentioned drying temperature from 40° C. to 150° C. prevails in the outlet chamber 15.

FIGS. 3a to 3e show how the vehicle bodies 2 coming from the pre-drier 4 are conducted through the lock 7. FIG. 3a shows how a vehicle body 2 is moved on to the support platform 27 through the inlet opening 16 of the inlet chamber 14, with the roll-up door 17 open, by means of a conveying system (not shown in detail). The support platform 27 is initially aligned horizontally. The conveying system mounted thereon can therefore take over the vehicle body 2 directly from the conveying system of the pre-drier 4. The roll-up door 17 is now closed again.

The vehicle body 2 can then remain for a certain time in the position shown in FIG. 3a, in which it is flushed with inert gas supplied via nozzles (not shown).

Next, the support plate 27 together with the vehicle body 2 is swivelled clockwise through approximately 90° until support platform 27 and vehicle body 2 are approximately vertical. This is represented in FIG. 3b. The swivelling arm 25 now begins to swivel anticlockwise, whereby the vehicle body 2 is immersed “head first” in the cold inert gas of the immersion bath 19. The swivelling movement of the swivelling arm 25 may be accompanied by a larger or smaller swivelling movement of the mounting frame 26 about the pivot axis 28, via which it is connected to the swivelling arm 25.

In this way the position shown in FIG. 3c, in which the swivelling arm 25 is positioned vertically and the support platform 27 with the vehicle body 2 is positioned horizontally, is reached. The immersion process thus takes place with minimum disturbance of the atmospheres present in the inlet chamber 14 and the immersion bath 19.

The anticlockwise swivelling movement of the swivelling arm 25 is continued, optionally again with a superposed swivelling movement of the mounting frame 26, about the pivot axis 28. In this way the position represented in FIG. 3d is reached, in which the free end of the swivelling arm 25 just extends into the outlet chamber 15 of the lock 7, and the support platform 27 with the vehicle body 2 is again vertical. The front part of the vehicle body 2 already projects into the warmer inert gas of the outlet chamber 15 while the rear part is still in the colder inert gas of the immersion bath 19.

There now follows another clockwise swivelling movement of the mounting frame 26 about the pivot axis 28, through approximately 90°, so that the support platform 27 and the vehicle body 2 are finally again horizontal (cf. FIG. 3e). The vehicle body 2 can now be moved in the direction of the arrow in FIG. 3e from the outlet chamber 15 into the drying tunnel 8 and can be taken over by the conveying system of the latter.

The above description of the operations taking place in the lock 7 makes it clear that the introduction of the vehicle bodies 2 into the inert gas atmosphere of the drying tunnel 8 takes place “in steps”. The expression “in steps” is understood to mean the conducting of the vehicle bodies 2 through different atmospheres in which the densities of the inert gas are different: the inlet chamber 14 contains only as much inert gas as enters said chamber through the “steaming” of inert gas from the immersion bath 19 via the opening 20 and, if applicable, via flushing nozzles which flush the body 2. The lowest density of the inert gas is therefore to be found in the inlet chamber 14. The highest density of the inert gas is present in the immersion bath 19, so that especially intensive flushing of the vehicle bodies 2 takes place in the latter.

The quantity of normal atmosphere, in particular oxygen, which is entrained into the immersion bath 19 via the vehicle body 2 is already sharply reduced because of the pre-flushing taking place in the inlet chamber 14. When the vehicle bodies 2 emerge from the immersion bath 19 into the outlet chamber 15 they are practically completely free of foreign gases, in particular oxygen.

As mentioned above, comparable operations take place in the outlet lock 9, although the transition here is from the inert gas atmosphere of the drying tunnel 8 to the normal atmosphere of the cooling zone 11. The primary purpose of the outlet lock 9 is to allow the least possible inert gas to cross into the cooling zone 11, which inert gas would be lost for the inert gas circulating in the drier 6.

FIG. 1 shows a conduit 29 which opens into the drying tunnel 8 from below. A secondary flow of inert gas is constantly drawn from the drying tunnel 8 via this conduit 29 and supplied to a condensate separator 30. The condensate separator 30 has one or more cooled plates past which the inert gas drawn from the drying tunnel 8 flows. Substances which can be separated out by condensation, in particular solvents, water, cracking products and other substances which are released from the coating of the vehicle bodies 2 during the drying process in the drier 6, are precipitated as condensate on the surfaces of the cooled plates.

To the extent that this precipitate comprises low-viscosity liquids, these can simply drain from the plates and be discharged in a suitable manner. However, in many cases high-viscosity precipitates are produced which must be removed mechanically and/or using solvents. For this purpose it is advantageous if the plates inside the condensate separator 30 are either easily accessible or easily removable.

In the process described, the inert gas which has been purified in the condensate separator 30 is cooled to a temperature which approximately matches the temperature of the cool inert gas in the immersion bath 19 of the lock 7. It is therefore returned via a conduit 31, in which a fan 32 is located, directly to the immersion bath 19 of the lock 7. Cooled inert gas may also be introduced into the immersion bath of the lock 9 in a corresponding manner.

The portion of a painting installation 101 illustrated in FIGS. 4 and 5 strongly resembles the embodiment described above with reference to FIGS. 1 and 2. Corresponding parts are therefore denoted by the same reference numerals, increased by 100. The spray cabin 103, the pre-drier 104 with the heating unit 105 and the cooling zone 111 with the cooling unit 112 are found unchanged in the embodiment of FIGS. 4 and 5. A drier 106, the drying tunnel 108 of which is filled with inert gas, is again located between the pre-drier 104 and the cooling zone 111. This inert gas is heated by means of a heating unit 110 to the above-mentioned temperature from 40° C. to 150° C.

However, unlike that of the embodiment of FIGS. 1 and 2, the drying tunnel 108 is not located at the same vertical level as the pre-drier 104 and the cooling zone 111, but is raised somewhat above that level. The transfer of the vehicle bodies 102 from the pre-drier 104 to the drying tunnel 108 and from the drying tunnel 108 to the cooling zone 111 is again effected via an inlet lock 107 and an outlet lock 109. The structure of the two locks 107, 109 is substantially the same, so that it will be sufficient to explain in more detail the construction of the lock 107 in the following exposition.

The lock 107 again comprises a housing 113 with an inlet chamber 114 and outlet chamber 115. The two chambers 114 and 115 communicate via a large-area opening 121 in the top of the inlet chamber and the bottom of the outlet chamber 115. A swivelling arm 125 is pivoted at one end to the housing 113 and can be swivelled back and forth in a motor-driven manner through an angle of approximately 90°. On its free end it again carries via a pivot axis 128 a mounting frame 126 with a support platform 127 which can receive the body 102 and is again provided with a conveying system which is compatible with the conveying systems in the pre-drier 104 and in the drying tunnel 108. The mounting frame 126 can be swivelled through at least 90° about the pivot axis 128 by means of a motor.

The inlet chamber 114 again has an inlet opening 116 which is closable by a roll-up door 117.

The outlet chamber 115 is filled with hot inert gas the density of which is lower than that of the normal atmosphere which is present in the inlet chamber 114. This means that the atmospheres in the inlet chamber 114 and the outlet chamber 115 remain largely separate from one another without a mechanical barrier. The inert gas atmosphere in the outlet chamber 115 may be substantially the same as the inert gas atmosphere in the drying tunnel 108.

The transfer of the vehicle bodies 102 through the lock 107 into the drying tunnel 108 is effected in the embodiment of FIGS. 4 and 5 as follows:

First, the swivelling arm 125 adopts the approximately horizontal position shown in FIG. 4. The mounting frame 126 is rotated with respect to the swivelling arm 125 so that the support platform 127 is horizontal. The roll-up door 107 can now be opened and a vehicle body 102 can be moved on to the support platform 127 by means of the conveying system. The roll-up door 107 is closed and the mounting frame 126 is rotated anticlockwise through approximately 90° so that the support platform 127 and the body 102 are approximately vertical. This is the position shown in FIG. 4. The rear of the vehicle body now projects into a corresponding downwardly recessed portion of the inlet chamber 114.

Next, the swivelling arm 125 is swivelled clockwise through approximately 90°, optionally accompanied by a swivelling movement of the mounting frame 126 about the pivot axis 128. In the course of this swivelling movement of the swivelling arm 125 the vehicle body 102 is guided upwardly in an arc into the outlet chamber 115 of the lock 107 until a position is finally reached in which the swivelling arm 125 is approximately vertical and the vehicle body 102 is approximately horizontal. The vehicle body 102 can then be taken over by the conveying system in the drying tunnel 108.

The operations in the outlet lock 109 follow the reverse sequence.

As in the embodiment of FIGS. 1 and 2, a secondary flow of inert gas is drawn from the inert atmosphere of the drying tunnel 108 via a conduit 129 and supplied to a condensate separator 130. The processes taking place in the condensate separator 130 and the construction thereof are identical to the processes and construction in the first embodiment. However, because a cooled inert gas is not used in the embodiment of FIGS. 4 and 5, the inert gas cooled in the condensate separator 130 must be reheated to the temperature prevailing in the drying tunnel 108. For this purpose the inert gas leaving the condensate separator 130 is supplied via a conduit 131, in which a fan 132 is located, to the heating unit 110 of the drying tunnel 108.

The flushing processes in the embodiment of FIGS. 4 and 5 are similar to those of the embodiment of FIGS. 1 and 2. That is, pre-flushing with inert gas, which optionally is also directed at the vehicle body 102 via nozzles, takes place in the inlet chamber 114 of the lock 107, and further flushing “in steps” takes place via the inert gas atmosphere prevailing in the outlet chamber 115 until the vehicle body enters the inert gas atmosphere of the drying tunnel 108. However, the flushing achievable is possibly not so effective as in the embodiment of FIGS. 1 and 2 because there is no zone in which an especially dense, because cool, inert gas is present.

FIGS. 6a to 6f represent an alternative embodiment of a lock 107 which may be used in place of the lock 7 or the lock 9 of the embodiment of FIGS. 1 and 2. In principle, the embodiment of FIGS. 6a to 6f closely resembles the embodiment of FIGS. 1 to 3; corresponding parts are therefore denoted by the same references increased by 200.

In a FIGS. 6a to 6f the pre-drier 204 located before the lock 207 and a portion of the drying tunnel 208 located after the lock 207 are indicated. The lock 207 itself includes a housing 213 which is divided into an inlet chamber 214, an immersion bath 219 and outlet chamber 215. The inlet chamber 214 is connected to the pre-drier 204 via an opening 216 which is closable by a roll-up door 217. The outlet chamber 215 communicates with the drying tunnel 208 via an opening 218, which may also have a roll-up door.

Direct transfer of atmosphere from the inlet chamber 214 to the outlet chamber 215 is again prevented by a vertical partition 222 which extends downwardly to somewhat below the floor level of the pre-drier 204 and the drying tunnel 208. The immersion bath 219 is filled with denser, in particular colder, inert gas than the outlet chamber 215.

In the embodiment of FIGS. 6a to 6f the transfer mechanism which moves the vehicle bodies 202 through the lock 207 includes two lifting tables 240, 241 with which respective support platforms 242, 243 can be moved vertically up and down. The support platforms 242, 243 are again provided with conveying systems which are compatible with the conveying systems in the pre-drier 204 and the drying tunnel 208.

A hood 244, the edges of which seal tightly with the walls of the inlet chamber 214, is arranged in a vertically movable manner in the inlet chamber 214 of the lock 207. The contour of the hood 244 is closely matched to the contour of the vehicle body 202.

The vehicle bodies 202 are moved through the lock 207 in the following manner:

As shown in FIG. 6a, with the roll-up door 217 open the vehicle body 202 is moved from the pre-drier 204 through the inlet opening 216 into the inlet chamber 214 of the lock 207 and on to the support platform 242 of the lifting table 240, which is raised for this purpose. The hood 244 is now lowered from above and moved very close to the vehicle body 202. As this happens the intervening air is largely displaced to the outside via an outlet flap 260 provided in the hood 244. Flushing with inert gas, which is directed for this purpose against the vehicle body 202 via nozzles, can still take place inside the inlet chamber 215. The quantity of inert gas required in this connection is, however, very much smaller than with the two embodiments described first, because the volume to be flushed is considerably reduced through the use of the hood 244.

Once this first flushing process in the inlet chamber 214 is concluded the support platform 242 of the lifting table 240 is lowered, as shown in FIG. 6c.

As the vehicle body 202 is lowered, it is immersed in the dense, cold inert gas contained in the immersion bath 219. In the lowest position, represented in FIG. 6c, the support platform 242 of the lifting table 240 is at the same level as the support platform 243 of the adjacent lifting table 241. As is apparent from FIG. 6d, the vehicle body 202 can therefore be transferred from lifting table 240 to lifting table 241. In the following step the support platform 243 of the lifting table 241 is raised in such a way that the conveying system of the support platform 243 reaches the same level as the conveying system inside the drying tunnel 208. In this process, the vehicle body 202 is raised into the outlet chamber 215 of the lock 207, in which the hot inert gas atmosphere is present (cf. FIG. 6e).

In a final step the vehicle body 202 is moved out in the direction of the arrow of FIG. 6f into the drying tunnel 208. At the same time the support platform 242 of the lifting table 240 is raised again. The hood 244 also returns to its raised position, so that the inlet chamber 214 of the lock 207 can be loaded with a new vehicle body 202.

During the raising of the hood 244 pressure is equalised via the outlet flap 260.

The flushing operations which take place with the embodiment of the lock 207 according to FIGS. 6a to 6f are identical to those described above with reference to FIGS. 3a and 3b for the lock 7 of the first embodiment.

FIG. 7 shows a portion of a painting installation 301 which corresponds functionally almost entirely to the embodiment of FIGS. 4 and 5. Differences lie above all in the following:

The swivelling arm 325 is pivoted to a wall of the inlet lock 307 located closer to the pre-drier 304 and at a higher position. As the vehicle body 302 is moved into the outlet chamber 315 the swivelling arm 325 is swivelled anticlockwise.

The end walls of the inlet lock 307 in which the inlet opening 316 and the outlet opening 318 are located are disposed not vertically but obliquely upwards, being adapted to the shape of the vehicle body 302. The volume of the corresponding chambers 314 and 315, and therefore the quantity of inert gas required, are thereby further reduced.

1. A method for drying objects in which the objects are moved through a drying zone in which they are cured in an inert gas atmosphere, wherein the objects, before passing through the drying zone, are conducted through a lock zone in which the normal atmosphere present outside the drying zone and an inert gas atmosphere are present in stratified form one above the other as a result of a difference of densities, the objects being transferred from the normal atmosphere to the inert gas atmosphere by a movement including a vertical component as they pass through the lock zone.

2. The method of claim 1, wherein the inert gas atmosphere has a higher density than the normal atmosphere.

3. The method of claim 2, wherein the inert gas is CO₂.

4. The method of claim 2, wherein the inert gas is cooled to a temperature that its density is higher than that of the normal atmosphere.

5. The method of claim 1, wherein the inert gas atmosphere has a lower density than the normal atmosphere.

6. The method of claim 5, wherein the inert gas is helium.

7. The method of claim 5, wherein the inert gas is heated to a temperature that its density is lower than that of the normal atmosphere.

8. The method of claim 1, wherein after passing through the first inert gas atmosphere the objects are conducted through a second inert gas atmosphere, the two inert gas atmospheres being present in stratified form one above the other as a result of a difference of densities.

9. The method of claim 8, wherein the second inert gas atmosphere has a lower density than the first inert gas atmosphere.

10. The method of claim 9, wherein the second inert gas is nitrogen or helium and the first inert gas is CO₂.

11. The method of claim 9, wherein the second inert gas is helium and the first inert gas is nitrogen.

12. The method of claim 9, wherein different densities are imparted to the two inert gases as a result of different temperatures.

13. The method of claim 4, wherein the first and second inert gases are CO₂ or nitrogen.

14. The method of claim 1, wherein after passing through the drying zone the objects are moved through a second lock zone from the inert gas atmosphere of the drying zone into the normal atmosphere present downstream of the drying zone, the second lock zone being of similar construction to the first lock zone but its atmospheres being traversed in the inverse sequence.

15. An apparatus for drying objects, the apparatus comprising:
a) a drying tunnel, the interior of which is filled with an inert gas atmosphere;
b) a conveying system with which the objects can be moved through the drying tunnel,
c) an inlet lock located before the drying tunnel and having:
ca) an inlet chamber into which the objects can be introduced via an inlet opening and in which the normal atmosphere present outside the apparatus substantially prevails;
cb) a second chamber which is located at a different vertical level to the inlet chamber, with which it communicates via a large-area opening and which is filled with an inert gas atmosphere,
cc) the normal atmosphere and the inert gas atmosphere being present in stratified form one above the other as a result of different densities; and,
d) a transfer mechanism with which the objects can be transferred from the inlet chamber to the second chamber by a movement including a vertical component.

16. The apparatus of claim 15, wherein the second chamber is arranged at a lower vertical level than the inlet chamber and the inert gas in the second chamber has a higher density than the normal atmosphere.

17. The apparatus of claim 16, wherein the inert gas is CO₂.

18. The apparatus of claim 16, wherein a cooling device is provided with which the inert gas contained in the second chamber can be cooled.

19. The apparatus of claim 15, wherein the second chamber is arranged at a higher vertical level than the inlet chamber and the inert gas in the second chamber (115) has a lower density than the normal atmosphere.

20. The apparatus of claim 19, wherein the inert gas is helium.

21. The apparatus of claim 19, wherein a heating device is provided with which the inert gas contained in the second chamber can be heated to a higher temperature.

22. The apparatus of claim 15, wherein the lock includes a third chamber which is located at a different vertical level than the second chamber, with which it communicates via a large-area opening and which is filled with a second inert gas atmosphere, the first and second inert atmospheres being stratified one above the other as a result of different densities.

23. The apparatus of claim 22, wherein the second inert gas has a lower density than the first inert gas.

24. The apparatus of claim 23, wherein the second inert gas is nitrogen or helium and the first inert gas is CO₂.

25. The apparatus of claim 23, wherein the second inert gas is helium and the first inert gas is nitrogen.

26. The apparatus of claim 18, wherein a cooling device and/or a heating device are provided with which different temperatures can be imparted to the inert gas in the second chamber and in the third chamber.

27. The apparatus of claim 18, wherein the inert gas in the second chamber and in the third chamber is CO₂ or nitrogen.

28. The apparatus of claim 15, wherein the transfer mechanism includes a swivelling arm one end of which is pivoted at a fixed location and the other end of which includes a holding device for the object.

29. The apparatus of claim 28, wherein the holding device is articulated to the swivelling arm.

30. The apparatus of claim 15, wherein the transfer mechanism includes at least one lifting table.

31. The apparatus of claim 15 further comprising an outlet lock proximate the end of the drying tunnel, the outlet lock being of similar construction to the inlet lock but the atmospheres of which are traversed in the inverse direction.
